(19) United States
(12) Patent Application Publication
(10) Pub. No.: US 2014/0229191 A1
(43) Pub. Date: Aug. 14, 2014

(54) PRESCRIPTION DECISION SUPPORT SYSTEM AND METHOD USING COMPREHENSIVE MULTIPLEX DRUG MONITORING

(71) Applicant: Sano Informed Prescribing, LLC, Brentwood, TN (US)

(72) Inventors: Douglas J. Ryan, Brentwood, TN (US); J. Murray Blackshear, Brentwood, TN (US); Timothy P. Ryan, Brentwood, TN (US)

(21) Appl. No.: 14/171,955

(22) Filed: Feb. 4, 2014

Related U.S. Application Data
(60) Provisional application No. 61/760,193, filed on Feb. 4, 2013.

(51) Int. Cl. G06Q 50/22

(52) U.S. Cl. CPC G06Q 50/22
USPC 705/2

(57) ABSTRACT

A system and method for informed prescribing implements a multiplex assay system to measure each of a plurality of chemical entities associated with a patient from a single body fluid sample, and identifies medication levels for each of the measured chemical entities relative to respective target ranges. A drug interaction program module such as a neutral network engine is iteratively trained using the identified medication levels and historical patient data from data storage. Program engines further measure an effectiveness of each of the chemical entities with respect to the historical patient data, and generate a recommended dosage for each of the plurality of chemical entities based on a drug interaction output from the drug interaction program module and the measured effectiveness. A user interface displays the results, and in an embodiment further provides alternative treatment options with respect to certain chemical entities based on drug interactions and/or effectiveness.

### CROSS-REFERENCES TO RELATED APPLICATIONS

This application claims benefit of the following patent application which is hereby incorporated by reference: U.S. Provisional Patent Application No. 61/760,193, filed Feb. 4, 2013.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### BACKGROUND OF THE INVENTION

The present invention relates generally to drug prescription practices for healthcare providers. More particularly, this invention relates to a system and method for diagnostic monitoring of drug and biomarker levels, relating these measured levels to other patient-specific characteristics, and utilizing this real-time and measurement-based drug level data for optimizing medication choice and dosages for patients taking more than one medication.

Therapeutic Drug Monitoring (TDM) is a term that describes the measurement of drug exposure in serum or plasma to tailor dosing in an individual patient. Tailored dosing in individuals is necessary because a multitude of parameters, such as body weight, overall health, patient behavior, and genotype underlie variable drug exposure in patients administered the same dose of a given medication. Different exposures result in different outcomes. For some drugs, such as the blood thinner Warfarin™, TDM is routine, with the physician starting, on a patient by patient basis, with very low doses and slowly titrating to efficacious blood levels to avoid potentially fatal bleeding.

TDM is not routinely practiced with most medications, not because exposure is any less dependent on individual patient parameters, but because it is not deemed necessary when the margin between efficacy and toxicity is wide. Therefore, TDM is typically deployed to avoid toxicity rather than to maximize the effectiveness of individual drugs.

Drug exposure is not only dependent upon the physical makeup of individual patients, but also upon interactions with other drugs that are concomitantly administered. Drug-drug interactions (DDI's) have a substantial impact upon patient outcomes, even with very commonly administered medications. Simvastatin™, for example, is one of the world's most prescribed medications. Co-administration of drugs that inhibit metabolic enzymes and transporters, such as cyclosporine, can drive Simvastatin™ exposure in individual patients upward more than ten-fold, increasing incidence of rhabdomyolysis, a serious and sometimes fatal toxicity of the muscle. This type of interaction is common, and nearly all new medications brought to market carry with them some interaction potential as either a perpetrator or victim of drug drug interactions despite the best efforts of the pharmaceutical industry (“pharma”).

One key point which is worth considering is that the therapeutic range of Simvastatin™ and virtually all other drugs are known or at least predetermined. Exposure and identification of medications outside of their range may be easily monitored by measuring drug levels in blood, but measuring drug exposure, especially the exposure of multiple drugs in unison, is not standard practice today. Assays that combine the measurement of drugs and biomarkers in multiplex format to decrease diagnostic costs while streamlining prescribing practices are further not previously implemented in the art.

The influence of genetics, patient characteristics and behaviors, environment, and drug-drug interactions on patient outcomes have all been studied on an individual basis, but currently have little impact on physician prescribing habits. Currently, a physician cannot account for the inherent complexity these parameters impart when prescribing a new medication to a patient, especially given that patients over 65 years of age are often taking 8 or more medications simultaneously. In fact, prospectively building models that predict drug exposure in an individual patient's overall treatment regimen to help guide physicians in drug selecting and dosing would require a comprehensive data set that simply does not exist today. Drug exposure in the light of complexity must be quantified if we are to understand drivers of patient variability.

Therefore, what is needed is a system and/or method for measuring the exposure of all concomitant medications in individual patients and a means to apply this information to inform physician prescribing practices. Such systems and methods may desirably serve one or more purposes including but not limited to: providing a real-world diagnostic monitoring; enabling better prescribing practices resulting in reduced risk for patients; yielding more effective treatment outcomes by increasing compliance, decreasing hospitilizations and optimizing medication choice; streamlining costs by integrating biomarker and therapeutic drug monitoring assays; producing valuable data necessary for prospective modeling of patient characteristics and reporting measures for better drug development in the future; and yielding critical insights on the benefit-risk and the real world effectiveness of pharmaceutical products for regulators, payers, HTA agencies, pharma and ultimately, patients.

It would be desirable that such systems and methods produce results easily for presentation to the physician in a simple format such that prescribing practices can be optimized for each patient in, e.g., a fifteen minute consultation.

Therefore, it would further be desirable to restrict the amount and scope of information provided, and to present this information in a graphical format with clear recommendations.

### BRIEF SUMMARY OF THE INVENTION

In accordance with various embodiments and associated aspects of the present invention, systems and methods as described herein are implemented for understanding patient variability in drug response resulting in the refinement of current prescribing practices and leveraging recent advances in mass spectrometry and informatics. A universal drug monitoring diagnostic tool is provided and executed for producing a simplified, comprehensive report that allows physicians to make informed prescription decisions in real time with individual patients.

Underlying this report are complexities that drive patient variability that are taken into account and presented to the physician in the form of drug selection and dosing recommendations. These constantly evolving/improving data-driven recommendations informed prescribing more so than current alert systems, which are overwhelmingly overridden in current practice today.

In one aspect of a system and method of the present disclosure, this diagnostic tool and associated implementation methods (which may in certain embodiments described further herein be referred to herein as “Comprehensive Informed Prescribing” or “CIP”) is a solution that leverages exposure of multiple medications and biomarkers simultaneously, allowing data-driven prescribing decisions based on individual drug levels in the context of for example other drugs, patient characteristics and reporting measures.

In another aspect, systems and methods as disclosed herein factor underlying patient, environmental and drug-driven variability and puts them in the hands of the physician in an easy to administer format.

In another aspect, systems and methods as disclosed herein may measure multiple (e.g., >100) chemical entities in a multiplex format for the purpose of providing quantitative data for informed dosing. Chemical entities include not just single victim drugs that fit the criteria for single drug monitoring, but perpetrator drugs that interact with victim drugs and drive DDIs. Further, endogenous biomarkers, non-prescription drugs, specified food additives, and natural products may be included in measurement. It is anticipated that demand created using this approach will result in improved multiplex assay formats being developed over time for the purpose of comprehensive informed prescribing, and the use of these multiplex assays for informed prescribing is also considered within the scope of various embodiments of a system and method as disclosed herein.

In another aspect, systems and methods according to the present disclosure may implement algorithms associating multiplex drug measurement data with patient meta-data and outcome data, models derived from these associations, and any novel recommendations that impact drug administration resulting from initial multiplex drug measurement. Associations may be made with non-traditional data, such as patient characteristics and behaviors, genetic makeup, disease state, and compliance (measured).

In another aspect, systems and methods according to the present disclosure may generate an informed prescribing report that allows physicians to make point-of-care decisions based on graphical output depicting each chemical entity detected, the measured value of that entity, the value of that entity relative to targeted therapeutic range, and recommendations based on the output from a contextual effectiveness database.

In another aspect, systems and methods according to the present disclosure may implement a comprehensive exposure/outcome database, models derived therein, and novel drug-drug and drug-chemical interactions detected using these models. The application of these models may extend back to drug development in the form of alerts for avoidable DDIs and previously unidentified avenues of unmet patient need.

In another aspect, systems and methods according to the present disclosure may implement multiplex drug measurement in streamlining assay cost, physician decision making, maintaining of patient health, improving compliance and overall efficacy, and preventing adverse events.

In another aspect, systems and methods according to the present disclosure measure all marketed drugs and produce an output of only relevant information that identifies information such as for example: which drugs the patient is taking (compliance); the level of each drug relative to the desired therapeutic range; and treatment options for each drug (including drug switching) when the level is either too high, too low, or subject to interactions leveraging context of the CIP database.

In another aspect, systems and methods according to the present disclosure generate and provide an output to a physician or other healthcare provider, having sufficient data and clear recommendations to treat the patient with autonomy. In various embodiments, additional parameters may include for example co-measurement of key select biomarkers, non-prescription medications and other influencing factors.

### BRIEF DESCRIPTION OF THE SEVERAL VIEWS OF THE DRAWINGS

FIG. 1 is a block diagram representing an exemplary embodiment of a system of the present disclosure.

FIG. 2 is a graphical representation of exemplary parameters as may be influencing individual drug levels with respect to a drug level monitoring process of the present disclosure.

FIG. 3 is a flowchart representing an exemplary process of the present disclosure.

FIG. 4 is a modified screen shot representing an exemplary user interface as a drug level report according to the present disclosure.

FIG. 5 is a modified screen shot representing an interactive version of the user interface of FIG. 4.

### DEFINITIONS

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Terms such as “providing,” “processing,” “supplying,” “determining,” “calculating” or the like may refer at least to an action of a computer system, computer program, signal processor, logic or alternative analog or digital electronic device that may be transformative of signals represented as physical quantities, whether automatically or manually initiated.

The term “Drug-drug interactions (DDIs)” as used herein may refer to at least interactions whereby one chemical entity has been demonstrated to or by inferences is expected to alter the level, efficacy, safety, or effectiveness of a prescribed medication when administered together.

The term “efficacy” as used herein may refer to at least the capacity to produce a desired clinical effect in a treated population relative to a population not treated with test drug. The desired effect may typically be measured based upon statistically significant patient cohort differences.

The term “effectiveness” as used herein may refer to at least some form of tangible, real world evidence as would be understood by those of skill in the art to demonstrate that an administered drug produces desired outcomes in individual patients.

The term “comprehensive informed prescribing” as used herein may refer to at least a process from initial patient consultation through outcome-driven patient care that utilizes multiplex drug measurement and associated tools allowing the physician to make data-driven decisions at the patient level in drug selection, prescribing changes, and dosage adjustments.

The term “multiplex drug measurement” as used herein may refer to at least the measure of more than one chemical entity using a single collection and assay format.

The term “perpetrator” as used herein may refer to at least a chemical entity that causes interference with a drug.

The term “personal comprehensive drug compendium” or “PCDC” may refer to at least a composition of all prescribed and non-prescribed medications that each individual patient is taking at time of physician visit.

The term “polypharmacy” as used herein may refer to at a prescribing practice where one patient is prescribed more than one concomitant medication.

The term “therapeutic range” as used herein may refer to at least a calculated or otherwise derived concentration range where efficacy has been demonstrated and toxicological side effects are avoided.

The term “victim drug” as used herein may refer to at least a drug whose levels are affected by perpetrators.

The term “Medical Therapy Management” or “MTM” as used herein may refer to at least a distinct service or group of services that optimizes drug therapy with the intent of improved therapeutic outcomes for individual patients. This model focuses on alerting drug interactions derived from a formulary or statistical approach.

The term “computer-readable memory medium” as used herein may refer to any non-transitory medium alone or as one of a plurality of non-transitory memory media having processor-executable software, instructions, program modules or the like which upon execution may provide data or otherwise cause a computer system to implement subject matter or otherwise operate in a specific manner as further defined herein. It may further be understood that more than one type of memory media may be used in combination to conduct processor-executable software, instructions, program modules or the like from a first memory medium upon which the software, instructions or program modules initially reside to a processor for execution.

“Memory media” may further include without limitation transmission media and/or storage media. “Storage media” may refer in an equivalent manner to volatile and non-volatile, removable and non-removable media, including at least dynamic memory, application specific integrated circuits (ASIC), chip memory devices, optical or magnetic disk memory devices, flash memory devices, or any other medium which may be used to stored data in a processor-accessible manner, and may unless otherwise stated either reside on a single computing platform or be distributed across a plurality of such platforms. “Transmission media” may include any tangible media effective to permit processor-executable software, instructions or program modules residing on the media to be read and executed by a processor, including without limitation wire, cable, fiber-optic and wireless media such as is known in the art.

The term “communications network” as used herein with respect to data communication between two or more parties or otherwise between communications network interfaces associated with two or more parties may refer to any one of, or a combination of any two or more of, telecommunications networks (whether wired, wireless, cellular or the like), a global network such as the Internet, local networks, network links, Internet Service Providers (ISP's), and intermediate communication interfaces.

### DETAILED DESCRIPTION OF THE INVENTION

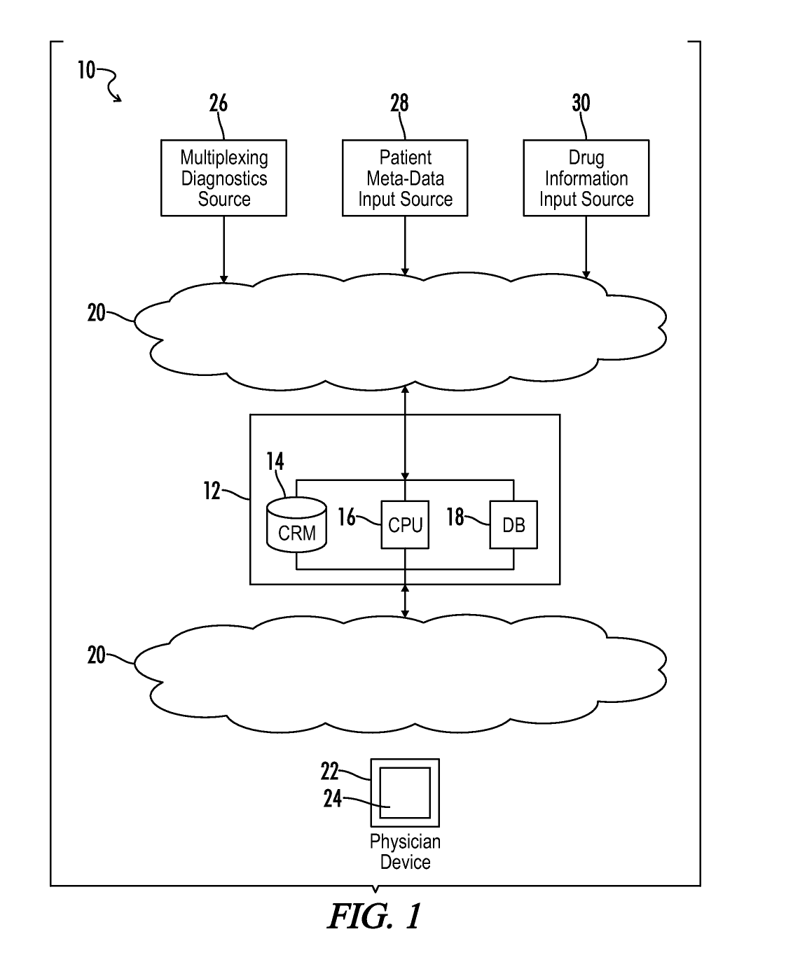

In various embodiments as disclosed herein, and by reference first to FIG. 1, a comprehensive informed prescribing system 10 may include one or more servers 12 upon which reside a processor 16, databases 18 and one or more computer-readable memory media 14. The memory media 14 have program instructions residing thereon which upon execution by the processor 16 are effective to direct the performance of steps collectively associated with methods of the present invention.

The system 10 may include or otherwise integrate or coordinate with an individual computing device 22 associated with a particular healthcare provider which is programmed to execute some or all steps of the method, and further effective to communicate via a communications network 20 and in distributed fashion with remote servers, databases 28, 30, multiplex assay systems 26 or the like for the purpose of facilitating certain steps of the method.

Alternatively, a central server may include components for performing most or all of the steps of an exemplary method in association with computers associated with the healthcare provider. For example, the steps in an exemplary method may be directed by program modules residing on a central server, based on requests or commands provided remotely from a healthcare provider using a mobile computing device, and further effective to generate a user interface such as for example a website accessible via a communications network to receive or provide data to and from the healthcare provider.

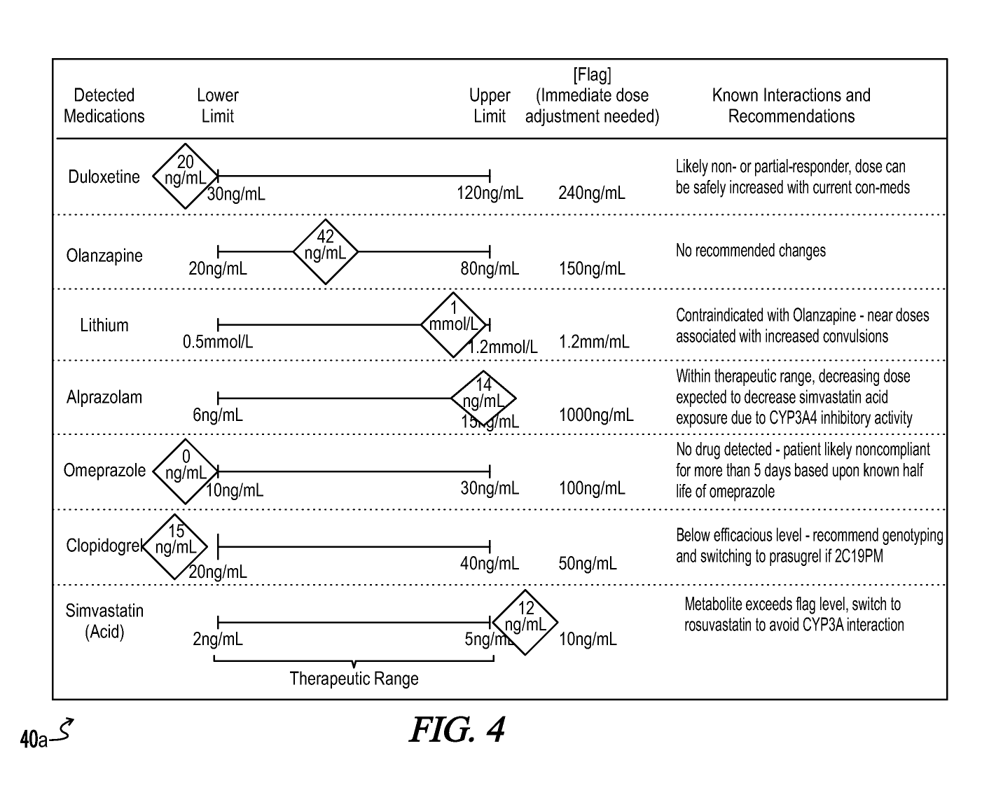

Systems and methods as disclosed herein may accordingly produce a single diagnostic that measures multiple biomarkers, marketed drugs and their active metabolites, giving the prescriber an unprecedented look into drug exposure that automatically takes into account heterogeneity of treatment for each patient. Furthermore, with reference to FIG. 4 by way of example, a simplified output could be formatted into a chart 40 from which dose and prescription decisions can be made and changed over time. With this diagnostic in hand, the prescriber has endpoint information directly influenced by genetics, physiology, DDIs, pharmaceutical compliance, all other covariates that effect drug exposure.

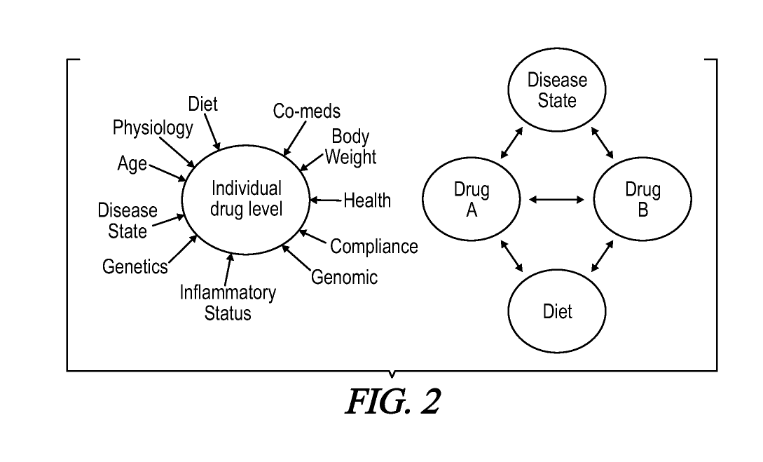

Furthermore, with this information, the prescriber would be able to determine which drugs are in the therapeutic range and hence, how to change dosing not for one, but every drug the patient is taking without bias and influence from doctor patient interactions. This is illustrated by way of example in FIG. 2.

It is conceived that a system and method as disclosed herein be provided to or accessible by physicians for leveraging the prescription network, databases, and informatics algorithms already developed within the industry. For example, the system may integrate or otherwise communicate with one or more remote servers and/or databases (collectively labeled as 30) for the purpose of obtaining, extracting or collecting data, requesting third-party execution of processing engines for the purpose of generating a desired analytics output, etc.

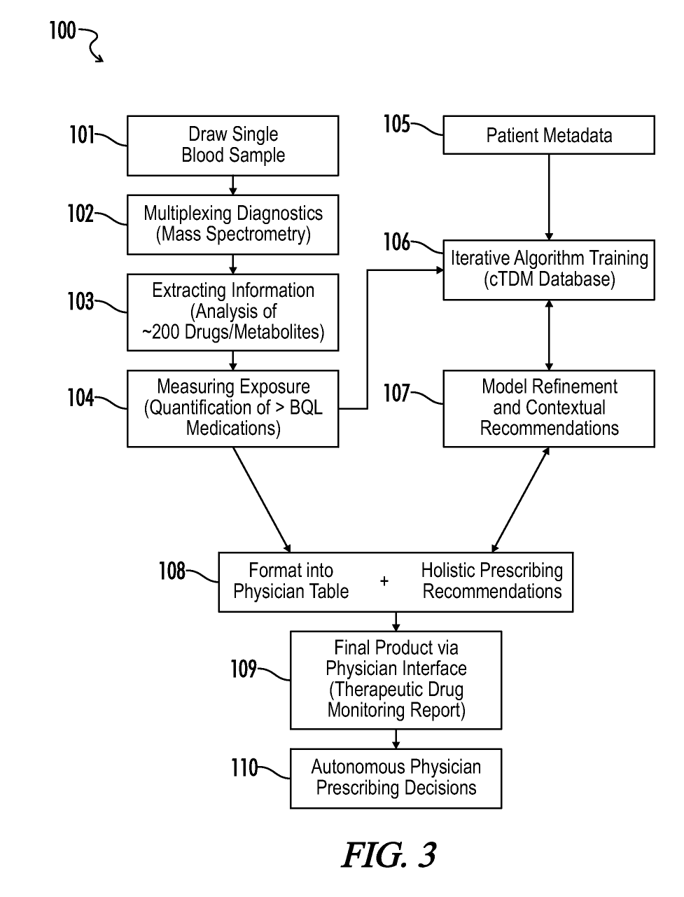

By reference next to FIG. 3, an exemplary embodiment of a method 100 according to the present invention may be performed as follows. The steps of the method may generally be performed in the order described, but such order is not necessarily limiting on the scope of the invention unless otherwise stated or inherently required. The described steps are not intended as being comprehensive in nature, and additional steps or sub-steps may be desirable for performing the method or otherwise achieving the purposes associated with the present invention, as may be understood by those of skill in the art.

As a preliminary matter, a patient profile may be generated in association with a particular patient (step 105). Accordingly, patient data may be gathered and incorporated into a contextual database data including, but not limited to, patient characteristics and behaviors, genetic makeup, disease state, non-prescription medications, diet, and other parameters known to influence drug levels.

Each of a plurality of chemical entities associated with a patient is measured in a multiplex assay from a single, non-invasive patient collection of body fluid such as, e.g., blood (steps 101, 102). As previously noted, methods to measure multiple drugs (e.g., >100) with different therapeutic indications for the purpose of comprehensive therapeutic range targeting are not widespread if even previously available in the art, making it cost and time prohibitive to monitor individual patient compliance, adjust dosage and choose medications appropriately. In accordance with a system and method of the present disclosure, a plurality of chemical entities including, but not limited to, commonly prescribed medications may be measured in a single assay format.

Generally stated, contemporary drugs are universally developed with an understanding of pharmacokinetic/pharmacodynamic or “PK/PD” principles. Accordingly, the individual molecular structures and estimated reference therapeutic ranges are known upon entry into the marketplace. Measuring drug levels on a single drug is known in the art using a multitude of technologies. The concept of expanding the measurement of a single molecular entity from one blood draw coupled with a single mass spectrometry run to measuring hundreds of molecular entities using the same blood sample via multiplex mass spectrometry is further available due to at least increased resolution in mass spectrometry technology, and deconvolution algorithms that can extract and quantify drug levels from the mass spectrum (step 103).

It is anticipated that demand created using an approach as disclosed herein may desirably result in improved multiplex assay formats being developed for the purpose of comprehensive informed prescribing, and the use of these multiplex assays for informed prescribing may also be considered within the scope of various embodiments of the present invention.

In various embodiments, systems and methods as disclosed herein generally rely upon the measurement of exposure of all drugs in serum or plasma to tailor dosing in individual patients taking multiple and simultaneous medications. Tailoring with respect to individuals is provided because a multitude of parameters, such as body weight, overall health, patient behavior, drug interaction, and genotype may typically underlie variable drug exposure in patients administered the same dose of a given medication (step 104). Different exposures result in different outcomes.

Medication levels are identified for each of the plurality of measured chemical entities relative to respective target therapeutic ranges. As represented in FIG. 4, the measurements may be formatted into a physician table along with holistic prescribing recommendations as further described below (step 108) and subsequently highlighted in a report or display associated with a user interface (step 109) with respect to minimum and maximum ends of a target range which is predetermined with respect to the various chemical entities, and obtainable from any of a number of external data sources.

A drug interaction program module is iteratively trained with the identified medication levels and either or both of incoming and historical patient data/parameters from the patient profile (106). The drug interaction program module or engine using appropriate algorithms may be executed to account for drug-drug interactions or the like using models based upon the measurement of multiple concomitant medications in the patient. Current methods for defining drug-drug interactions typically use models derived from in vitro, ex vivo, and small pair-wise clinical trial data. Dosing recommendations and contraindication information are thus limited by these fragmentary input data. In accordance with the present disclosure, iterative training of a proprietary model over time with incoming data may facilitate individual PCDC drug-drug interaction recommendations based upon multiple interacting medications in light of all other parameters measured in effectiveness research. In various embodiments of the present invention, a number of associations may be further made available using the novel data source whereby concomitant drug levels are used as covariates in the derivation of dosing advisement and recommendations.

In various embodiments, a drug choice and dosage recommendation program module may be executed to generate a recommended dosage for each of the plurality of chemical entities based on an output from the drug interaction program module and a determined effectiveness for each of the plurality of chemical entities (step 107). Current best-practice prescribing for individual medications is dosage-based and driven by drug labels that are constructed from controlled clinical trials. These clinical trials measure average efficacy, safety, and biopharmaceutical endpoints in controlled patient populations. The dosage recommendation program module and associated algorithms may alternatively generate data-driven dosing outputs based upon measured individual drug levels targeting therapeutic ranges defined by real-world effectiveness data. Accordingly, individual drug measurement in an accessible body fluid as previously described accounts for all parameters impacting individual patient drug disposition and may be viewed in the context of an effectiveness database.

Further, treatment options for physicians as previously known in the art are primarily formulary driven. There is no tool that informs patient prescribing that can bring data to the physician to allow real-time patient prescribing decisions in patient setting.

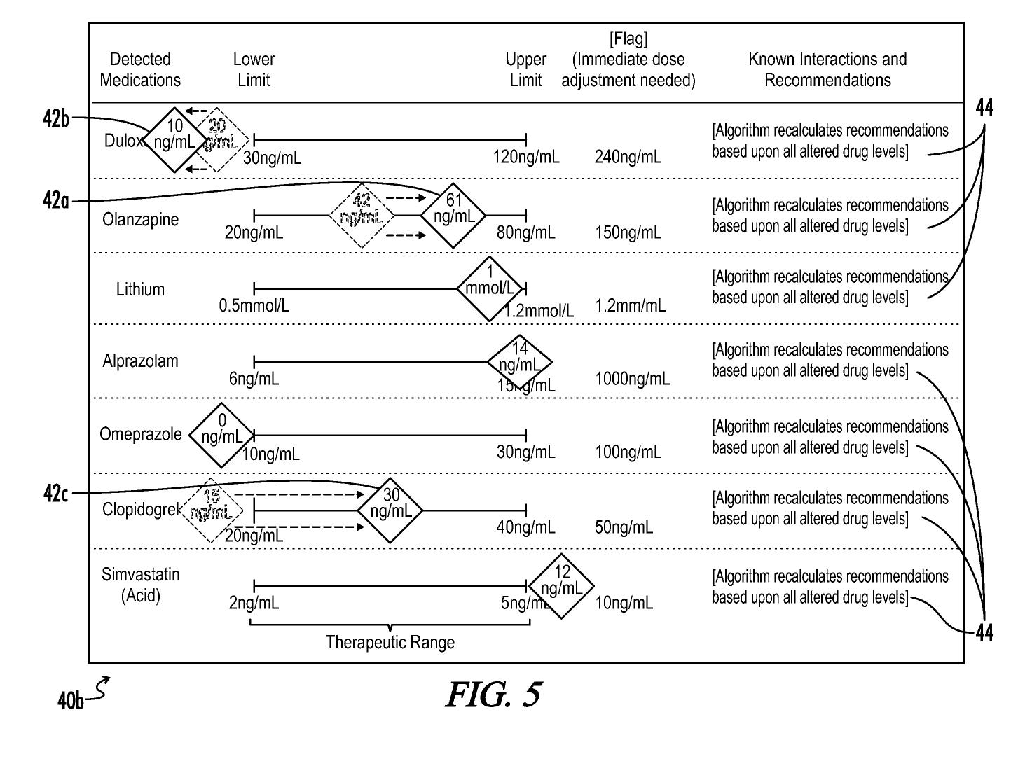

Accordingly, and by further reference again to FIG. 4, any one or more of the recommended dosage, the identified medication levels, the target therapeutic ranges, and other desired information may be presented to a user such as a healthcare provider via a graphical user interface which may for example be executable from any of a number of types of mobile computing device associated with the healthcare provider. Please note that the medications and associated values, ranges, flags, interactions and recommendations provided in both of FIGS. 4 and 5 are completely hypothetical and are presented for illustrative purposes only and without limitation.

Alternatively, a report may be generated in electronic form and downloadable by the healthcare provider or otherwise locally printable, or various equivalent delivery modes as may be understood by those of skill in the art.

Referring now to FIG. 5, in an embodiment the report may further be generated in an interactive format 40b wherein the user may selectably modify one or more of the measured drug levels. Hosted algorithms associated with the system of the present invention may in various embodiments subsequently recalculate or otherwise determine the various drug-drug interactions, dependencies, target therapeutic ranges, and any other relevant report output as may be influenced by or otherwise relevant to the new user selection. For example, if a user were to select the measured value for Olanzapine (42 ng/mL), which selection may be made by for example touching the relevant icon 42a via a touch screen display or otherwise by mouse selection or any of a number of equivalents as are known in the art, and slide the icon 42a to any other value along the represented scale (and even potentially outside of the lower and upper limits), the system may be programmed to reevaluate one or more of the other values, for example those for Duloxetine 42b and/or Clopidogrel 42c as represented in FIG. 5. In this instance, if the user were to select a higher value of Olanzapine, the system may further revise the flag level, revise the target level or otherwise provide comments with respect to for example Lithium, as there are known contraindications with respect to these two medications.

A graphical user interface such as a touch screen dashboard display in accordance with various embodiments of the present invention may therefore be implemented for the purpose of establishing base data for a patient profile or to receive input parameters for one or more associated algorithms, and further may after initial presentation of output values allow for user manipulation of one or more output values to resubmit some or all of the results for recalculation, reevaluation and subsequent presentation of alternative results. A physician may therefore monitor potential courses of action in real-time based on suggested dosing or drug selection, rather than relying solely on future results from current doing and drug selection.

It may be understood by those of skill in the art that results may be fed over time into system processing engines such as for example neural network, or machine learning, engines that implement advanced algorithms for improving upon the associations, interactions, recommendations and other results with respect to initial iterations of the process. Particularized informational databases and associated program modules may be provided within the scope of the present invention for operating on the relevant data.

The previous detailed description has been provided for the purposes of illustration and description. Thus, although there have been described particular embodiments of the present invention, it is not intended that such references be construed as limitations upon the scope of this invention except as set forth in the following claims.

What is claimed is:

1. A computer program product comprising a non-transitory computer readable medium having program instructions residing thereon, the instructions executable by a processor to direct the performance of operations further comprising:
receiving data from a multiplex assay system representative of measured values for each of a plurality of chemical entities in a body fluid sample associated with a patient;
identifying medication levels for each of the plurality of measured chemical entities relative to respective target ranges;
iteratively training a drug interaction program module with the identified medication levels and historical patient data;
measuring an effectiveness of each of the plurality of chemical entities with respect to the historical patient data;
executing a dosage recommendation program module to generate a recommended dosage for each of the plurality of chemical entities based on a drug interaction output from the drug interaction program module and the measured effectiveness; and
generating a user interface accessible via a display unit for a user computing device, the user interface comprising identified medication levels, the respective target ranges, and the respective recommended dosages for each of one or more corresponding chemical entities associated with the patient.

2. The computer program product of claim 1, the user interface further comprising alternative treatment options with respect to each of the one or more chemical entities.

3. The computer program product of claim 2, the user interface further comprising one or more user-selectable visual elements for each of the one or more chemical entities, wherein the user interface enables manipulation of the respective elements by a user from a first medication level to a second medication level.

4. The computer program product of claim 3, the instructions executable by a processor, in response to user manipulation of a visual element for a first chemical entity from a first medication level to a second medication level, to further direct the performance of dynamically recalculating one or more of the identified medication level, target range, recommended dosage and alternative treatment options for one or more chemical entities.

5. The computer program product of claim 1, wherein identifying medication levels for each of the plurality of measured chemical entities relative to respective target ranges comprises identifying drug and biomarker levels for each of the plurality of measured chemical entities relative to respective biomarker and target therapeutic ranges.

6. The computer program product of claim 5, the historical patient data comprising data obtained from data storage functionally linked to the processor, the data further comprising one or more parameters known to influence medication levels.

7. The computer program product of claim 1, the dosage recommendation module effective to determine effectiveness associations wherein concomitant medication levels are used as covariates in generating recommended dosages for each of the plurality of corresponding chemical entities.

8. A server system comprising a processor, data storage comprising historical patient data and general chemical entity effectiveness data, and a computer-readable medium having program instructions residing thereon, the instructions executable by the processor to direct the performance of operations further comprising:
implementing a multiplex assay system to measure each of a plurality of chemical entities associated with a patient from a body fluid sample;
identifying medication levels for each of the plurality of measured chemical entities relative to respective target ranges;
iteratively training a drug interaction program module with the identified medication levels and historical patient data obtained from the data storage;
measuring an effectiveness of each of the plurality of chemical entities with respect to the historical patient data; and
executing a dosage recommendation program module to generate a recommended dosage for each of the plurality of chemical entities based on a drug interaction output from the drug interaction program module and the measured effectiveness.

9. The server system of claim 8, the multiplex assay system comprising one or more mass spectrometers, and a deconvolution algorithm effective to extract and quantify a plurality of medication levels from an associated mass spectrum.

10. The server system of claim 8, the dosage recommendation module effective to determine effectiveness associations wherein concomitant medication levels are used as covariates in generating recommended dosages for each of the plurality of corresponding chemical entities.

11. The server system of claim 8, the patient data further comprising one or more parameters known to influence medication levels.

12. The server system of claim 8, the instructions further executable by a processor to direct the performance of
generating a user interface accessible via a display unit for a user computing device, the user interface comprising identified medication levels, the respective target ranges, and the respective recommended dosages for each of one or more corresponding chemical entities associated with the patient.

13. The server system of claim 12, the user interface further comprising alternative treatment options with respect to each of the one or more chemical entities.

14. The server system of claim 13, the user interface further comprising one or more user-selectable visual elements for each of the one or more chemical entities, wherein the user interface enables manipulation of the respective elements by a user from a first medication level to a second medication level.

15. The server system of claim 14, the instructions executable by a processor, in response to user manipulation of a visual element for a first chemical entity from a first medication level to a second medication level, to further direct the performance of dynamically recalculating one or more of the identified medication level, target range, recommended dosage and alternative treatment options for one or more chemical entities.

16. The server system of claim 8, wherein identifying medication levels for each of the plurality of measured chemical entities relative to respective target ranges comprises identifying drug and biomarker levels for each of the plurality of measured chemical entities relative to respective biomarker and target therapeutic ranges.

17. A computer-implemented method comprising:
implementing a multiplex assay system to measure each of a plurality of chemical entities associated with a patient from a body fluid sample;
identifying medication levels for each of the plurality of measured chemical entities relative to respective target ranges;
iteratively training a drug interaction program module with the identified medication levels and historical patient data;
measuring an effectiveness of each of the plurality of chemical entities with respect to the historical patient data; and
generating a recommended dosage for each of the plurality of chemical entities based on a drug interaction output from the drug interaction program module and the measured effectiveness.

18. The method of claim 17, further comprising generating a user interface accessible via a display unit for a user computing device, the user interface comprising identified medication levels, the respective target ranges, and the respective recommended dosages for each of one or more corresponding chemical entities associated with the patient.

19. The method of claim 18, further comprising enabling user manipulation of one or more user-selectable visual elements from a first medication level to a second medication level for each of the one or more chemical entities via the user interface.

20. The method of claim 19, wherein in response to user manipulation of a visual element for a first chemical entity from a first medication level to a second medication level, the method further comprises dynamically recalculating one or more of the identified medication level, target range, recommended dosage and alternative treatment options for one or more chemical entities.
